(19) United States
(12) Patent Application Publication
(10) Pub. No.: US 2019/0283130 A1
(43) Pub. Date: Sep. 19, 2019

(54) 3D PRINTING PROCESS

(71) Applicant: Flender GmbH, 46395 Bocholt (DE)

(72) Inventor: RALF MARTIN DINTER, Gelsenkirchen (DE)

(73) Assignee: Flender GmbH, 46395 Bocholt (DE)

(21) Appl. No.: 16/339,246

(22) PCT Filed: Oct. 4, 2017
(86) PCT No.: PCT/EP2017/075226

§ 371 Date: Apr. 3, 2019

(30) Foreign Application Priority Data
Oct. 13, 2016 (EP) 16193612.5

(51) Int. Cl. B22F 3/00; B33Y 10/00; B33Y 50/02; B22F 3/24; B33Y 40/00; B33Y 80/00

(52) U.S. Cl. CPC B22F 3/008; B33Y 10/00; B33Y 50/02; B22F 2003/248; B33Y 40/00; B33Y 80/00; B22F 2003/247; B22F 3/24

(57) ABSTRACT

In a 3D printing process for building up components layer by layer, an individual set of CAD data is created that takes into account a dimension of a working chamber of a 3D printing machine and is based on structural design data of a plurality of components to be produced. The set of CAD data defines form and position of the components in the three-dimensional space and form and position of supporting structures connecting at least some of the components to one another. The position of at least some components is chosen as to be arranged one above the other and/or nested in one another in a direction of production. The components and the supporting structures are built up layer by layer from a material by using a 3D printing machine and the set of CAD data in a single operation and the components are separated from the supporting structures.

The present invention relates to a 3D printing process for building up components layer by layer on the basis of a set of CAD data and using a 3D printing machine having a wonting chamber.

3D printing processes of the type mentioned in the introduction are known in a wide variety of embodiments in the prior art. Using them, it is possible to build up three-dimensional workpieces layer by layer on the basis of a set of CAD data comprising structural design data from different materials by way of physical or chemical hardening or melting processes, with the STL format being the most common data format. 3D printing processes include, inter alia, selective laser melting and electron beam melting, in particular for processing metal materials, selective laser sintering for polymers, ceramic and metals, polyjet modeling and fused deposition modeling for processing synthetic resins and plastics materials, and also stereolithography and digital light processing in which liquid synthetic resins are used.

While 3D printing processes were initially used primarily in the construction of prototypes and models, they are increasingly also being used in series production. A fundamental advantage consists, inter alia, in that workpieces with very complex forms, which can only be produced with difficulty, or not at all, using alternative production processes, can be produced. Furthermore, the 3D printing processes are usually advantageous in terms of energy and require only a little material.

Common to all known 3D printing processes is that the workpieces within a working chamber are built up with a usually rectangular base area. Base area and height of the working chamber determine the maximum workpiece dimensions that can be produced inside the corresponding 3D printing machine. If a component to be produced has relatively small dimensions, then it is also known in series production to generate a plurality of identical components layer by layer and side by side on the base area of the working chamber. In this case the size of the base area of the working chamber then also determines the number of workpieces that can be produced simultaneously.

Starting from this prior art it is an object of the present invention to provide a process of the type mentioned in the introduction, with which, in particular, the production of a large number of components having an identical design or different designs can be accelerated.

To achieve this object the present invention creates a 3D printing process of the type mentioned in the introduction, which has the following steps:
a) creating an individual set of CAD data that takes into account the dimensions of the working chamber and is based on structural design data of a plurality of components to be produced, which defines the form and the position of the components in the three-dimensional space and also the form and position of supporting structures connecting at least some of the components to one another, wherein the position of at least some components is chosen in such a way that they are arranged one above the other and/or nested in one another in the direction of production;
b) building up the components and the supporting structures layer by layer from a material by using the 3D printing machine and the set of CAD data created in step a) in a single operation and
c) separating the components from the supporting structures.

The idea underlying the invention consists in making optimum use of the size of the existing working chamber of a 3D printing machine. This optimum utilization is inventively achieved in that the structural design data of a plurality of components to be produced is incorporated and virtually arranged in an individual set of CAD data in such a way that at least some of the components are produced one above the other and/or nested in one another in the direction of production. Accordingly, in most cases more components can be generated in a single operation compared to the case in which components to be produced are built up solely side by side. In this way the production time of components can be reduced in many cases by using the inventive 3D printing process. To enable production of a plurality of components arranged one above the other or nested in one another, in addition to the components to be produced, at least some of the components of supporting structures for connecting to one another are also defined in the set of CAD data. Until now such supporting structures have been used in the prior art only to produce undercuts or similar structures of an individual component.

The supporting structures are preferably defined in step a) as web-like and/or honeycombed supporting structures since supporting structures of this kind have the required stability and may be separated relatively easily from the components following production.

According to one embodiment of the present invention, the components to be produced are single parts of an assembly for producing an individual device, with the external dimensions of at least some of the components that are to be produced at the same time differing from each other. The compilation of construction engineering-related data of a large number of single parts of an assembly in a common set of CAD data has the advantage that the single parts do not have to be produced individually one after the other and do not have to be kept in stock in large numbers either. Instead, they can be generated together within a short time as soon as, for example, the corresponding assembly is ordered by a customer. Rapid availability of an assembly of this kind is accordingly ensured while simultaneously easing the need for storage, and this can result in significant cost savings.

According to the invention, the device can be a gear. In this case, for example housing parts, planetary carriers and the individually toothed components can form the single parts for producing the gear.

According to one embodiment of the present invention, single parts make up at least 50%, preferably at least 70%, even better at least 90% of the total number of single parts of the assembly, with the total number in the present case not including standard or purchased parts, for example in the form of connecting means, such as, for example screws and pins, of bearings or the like.

A metal material is preferably used in step b) from which the components and also the supporting structures are built up.

According to one embodiment of the present invention, the components are subjected to mechanical re-machining and/or thermal post-treatment if component joints, component dimensions or the like should not satisfy the requirements.

Further features and advantages of the present invention will become clear on the basis of the following description of an exemplary embodiment of an inventive 3D printing method and with reference to the accompanying drawings, in which:

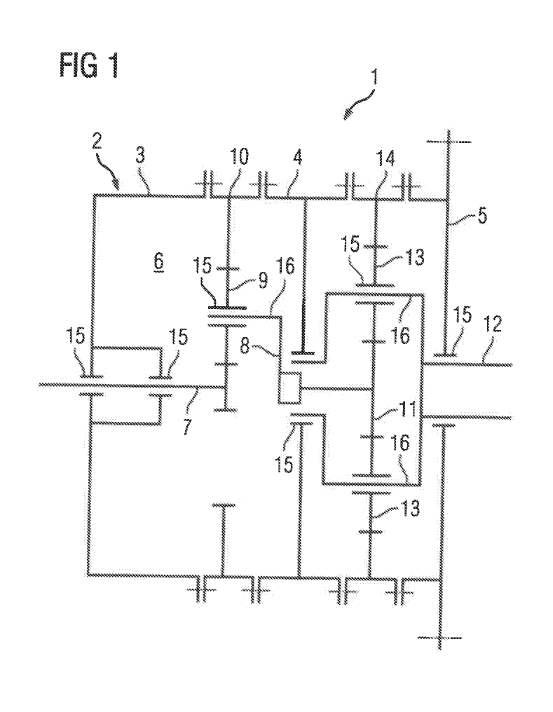

FIG. 1 shows a schematic sectional view of a two-stage planetary gear,

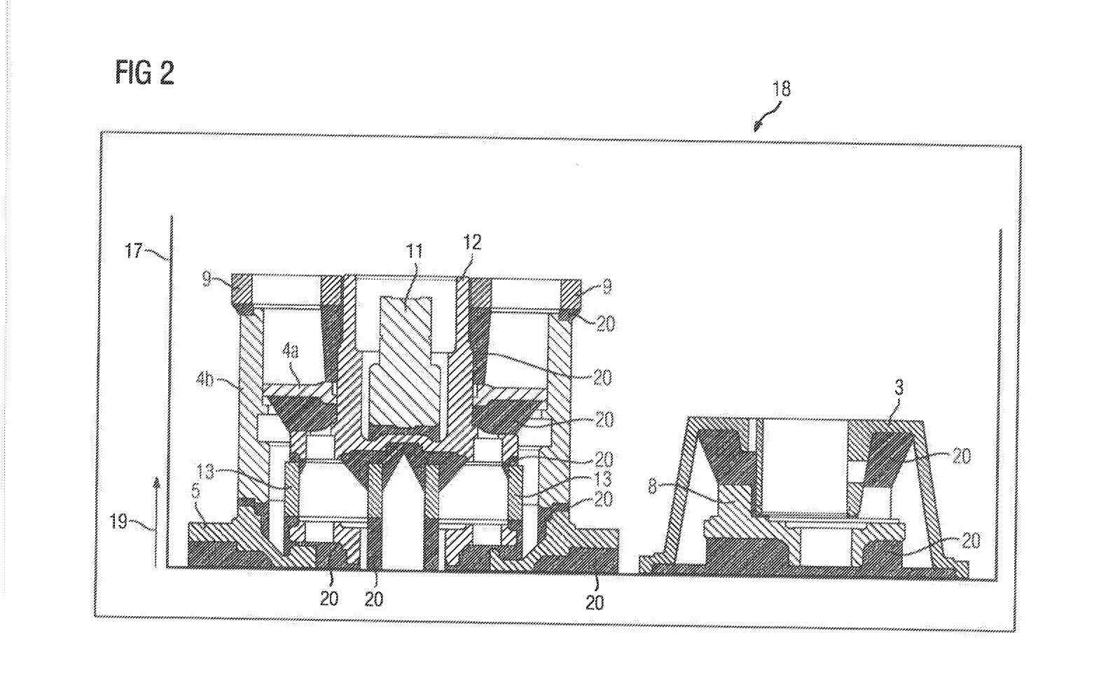

FIG. 2 shows a schematic sectional view illustrating the single parts of the gear shown in FIG. 1 in a state produced layer by layer at the end of a 3D printing process according to one embodiment of the present invention.

FIG. 1 shows a two-stage planetary gearing 1 whose single parts are for the most part simultaneously produced using a 3D printing process according to one embodiment of the present invention, as will be explained in more detail below with reference to FIG. 2. The left of FIG. 1 shows the drive side and the right, the power take-off side.

The planetary gearing 1 comprises a housing 2 having a housing bell 3, a first housing flange 4 and a second housing flange 5 which together define a receiving space 6 for the gear parts. Further main components of the planetary gearing 1 are formed by a preliminary stage sun wheel shaft 7, a preliminary stage planetary carrier 8, three preliminary stage planetary wheels 9, a preliminary stage hollow wheel 10, a main stage sun wheel shaft 11, a main stage planetary carrier 12, four main stage planetary wheels 13 and a main stage hollow wheel 14.

The housing bell 3 and the first housing flange 4 between them receive the preliminary stage hollow wheel 10 in a rotatably fixed manner and the first housing flange 4 and the second housing flange 5 between them receive the main stage hollow wheel 14 in a rotatably fixed manner. The preliminary stage sun wheel shaft is mounted on the housing bell by way of suitable bearings 15. The main stage planetary carrier 12 is also held in a rotatably fixed manner on the first housing flange 4 by means of suitable bearings 15. The preliminary stage planetary carrier 8 is mounted in a rotatably fixed manner on the main stage sun wheel shaft 11 by a suitable shaft-hub connection. The preliminary stage planetary carrier 8 comprises at least three pins 16 on which the preliminary stage planetary wheels are held by suitable bearings 15. The main stage planetary wheels 13 are also fastened to pins 16 of the main stage planetary carrier 12 by means of suitable bearings 15. The preliminary stage sun wheel shaft 7 is engaged with the preliminary stage planetary wheels 9 which in turn mesh with the preliminary stage hollow wheel 10. The main stage sun wheel shaft 11 is also engaged with the main stage planetary wheels 13 which in turn mesh with the main stage hollow wheel 14. A rotation of the preliminary stage sun wheel shaft 7 accordingly leads to a joint low-speed rotation of the preliminary stage planetary carrier 8 and the main stage sun wheel shaft 11 and a rotation of the main stage sun wheel shaft 11 in turn leads to a low-speed rotation of the main stage planetary carrier 13.

Planetary gearings of the type described above are known per se for which reason the specific construction of the planetary gearing 1 should not be regarded as limiting. Instead, the planetary gearing 1 should be understood as a preferred example of any device that is produced from a large number of single parts.

Production of a large number of single parts of the gear illustrated in FIG. 1 will be described below with reference to FIG. 2 and, more precisely, the housing bell 3, the first housing flange 4, the second housing flange 5, the preliminary stage planetary carrier 8, the preliminary stage planetary wheels 9 the preliminary stage hollow wheel 10, the main stage sun wheel shaft 11, the main stage planetary carrier 12, the main stage planetary wheels 13 and the main stage hollow wheel 14.

In a first step a single set of CAD data is created on the basis of structural design data of all of the above-mentioned single parts, which dataset, in addition to the form of the individual components, also defines their position in relation to each other in the three-dimensional space by taking into account the dimensions of a working chamber 17 of a 3D printing machine 18, which is to be used for producing the single parts. As shown in FIG. 2, the individual components are arranged at least partially nested in one another and one above the other in the direction of production. For example, according to FIG. 2, the second housing flange 5 illustrated in FIG. 1, the main stage hollow wheel 14, the first housing flange 4, the preliminary stage hollow wheel 10 and the preliminary stage planetary wheels 9 are arranged in turn one above the other, with the main stage hollow wheel 14, the first housing flange 4 and the preliminary stage hollow wheel 10 being combined in the components 4a and 4b while the main stage planetary carrier 12, the main stage planetary wheels 13 and the main stage sun wheel shaft 11 are positioned inside these components and nested in one another. Provided next to this arrangement is the housing bell 3, inside which the preliminary stage planetary carrier 8 is in turn received. Furthermore, the set of CAD data defines the form and position of supporting structures 20 connecting the components together, which structures can be designed, in particular to be web-like and/or honeycombed. The set of CAD data, which can be provided, for example. In the STL format, is created at least partially automatically using an appropriate computer program. Therefore, for example the arrangement of the single parts and/or the calculation and position of the supporting structures 20 can be automatic or assisted by a user.

In the present case, as already illustrated, the components 4a and 4b combine the main stage hollow wheel 14. the first housing flange 4 and the preliminary stage hollow wheel 10. On assembly, the component 4a is then pushed onto the component 4b and shrunk-on. However, it should be clear that the main stage hollow wheel 14, the first housing flange 4 and the preliminary stage hollow wheel 10 basically can be produced also as single parts respectively. In this case they then have to be separated from each other by way of corresponding supporting structures.

In a further step the components and the associated supporting structures 20 are then built up layer by layer in a single operation from one material using the 3D printing machine 18 and the set of CAD data created previously until the arrangement illustrated in FIG. 2 is produced. In the present case, in particular powdered or wire-like metals or metal alloys can be used as the material. If the method is used to produce individual components of an assembly, rather than a gear, in order to produce a different device, which is produced from a different material, then the starting material can of course also be a plastics material, a ceramic material or the like.

The components of the supporting structures 20 are subsequently separated and, should it be necessary, subjected to mechanical re-machining and/or thermal post-treatment.

It should be clear that, alternatively, all main components of the planetary gearing 1, in the present case also the preliminary stage hollow wheel 7 therefore, can be produced in a single operation if the dimensions of the working chamber permit this. Alternatively, fewer than said individual components of the planetary gearing 1 can also be produced in a single operation. For example, the situation can occur where the 3D printing process is not suitable for producing particular components due to external requirements, for which reason such components are produced using other production methods. It is of course also possible to distribute the single parts of a device among a plurality of sets of CAD data if this is necessary due to excessively small dimensions of the working chamber 17. The inventively produced single parts make up preferably at least 50%, preferably at least 70%, even better at least 90% of the total number of single parts of an assembly.

Although the invention has been illustrated and described in detail by the preferred exemplary embodiment, it is not limited by the disclosed examples and a person skilled in the art can derive other variations herefrom without departing from the scope of the invention.

1.-7. (canceled)

8. A 3D printing process, comprising:
creating an individual set of CAD data by taking into account a dimension of a working chamber of a 3D printing machine and based on structural design data of a plurality of components to be produced, to thereby define form and position of the components in a three-dimensional space and to define form and position of supporting structures connecting at least some of the components to one another, with the position of the at least some of the components being chosen in such a way that they are arranged one above the other and/or nested in one another in a direction of production;
building up the components and the supporting structures layer by layer from a material by using the 3D printing machine and the created set of CAD data in a single operation; and
separating the components from the supporting structures, with the components forming single parts of an assembly for producing a gear, with the single parts amounting to at least 50% of a total number of single parts of the assembly.

9. The 3D printing process of claim 8, wherein the single parts amount to 70% of the total number of single parts of the assembly.

10. The 3D printing process of claim 8, wherein the single parts amount to 90% of the total number of single parts of the assembly.

11. The 3D printing process of claim 8, wherein the supporting structures are configured as web-like supporting structures.

12. The 3D printing process of claim 8, wherein the supporting structures are configured as honeycombed supporting structures.

13. The 3D printing process of claim 8, wherein the material is a metal material.

14. The 3D printing process of claim 8, further comprising subjecting the components to at least one process selected from the group consisting of mechanical re-machining and a thermal post-treatment.
